(19) United States
(12) Patent Application Publication
(10) Pub. No.: US 2006/0119094 A1
(43) Pub. Date: Jun. 8, 2006

(54) Map with flap with integrated standard punched hole or integrated standard punched hook

(76) Inventor: Kaj Berndtson, Schoengeising (DE)

Correspondence Address: Kaj Berndtson, Enterbruck 11, Schoengeising, D-82296, DE

(21) Appl. No.: 11/237,704

(22) Filed: Sep. 29, 2005

(30) Foreign Application Priority Data
Sep. 30, 2004 (DE) 20 2004 015 334.3
Feb. 11, 2005 (DE) 20 2005 002 197.0

(51) Int. Cl. G09B 29/00

(52) U.S. Cl. 283/34

(57) ABSTRACT

A map, having a printed sheet of paper or synthetic paper and optionally having a lamination or lining on one or both sides, and having fanfold lines extending in one direction. At least three cross fold lines extend perpendicular to the fanfold lines, and are central of the map sheet and form a round spine. The spaces between the cross fold lines have a maximum of 1.5 mm and all fold lines are predefined by grooving. Optionally the round map spine is formed by heating up to 40° C. to 200° C. and deformation and remains permanent after cooling down. This map spine can bear a short information. Furtheron such a map or a known map is connected permanently or temporarely with a firm or detachable falp with an integrated punched hole or an integrated punched hook, which enables a hanging up on a hook of the sales system peg-boards with s-hook.

The invention relates to a known map but also to Inventive Map as e.g. a country map, a road map, a street map, a city map, a hiking map, a bike map, a mountain bike map, motor cycle map, a public transport map, a nautical chart, a aviation chart, a pilotage chart, a geological chart, a achitectural plan, but also an infomation sheet, which is printed on a large sheet and is folded like map to a small and easy manageable format and an otherwise printed map sheet.

“Known maps” have various embodiments, whereas those are predominant where the map sheet is made of printed paper, card, sythetic paper or synthetics. Such maps produced of the first two materials ware comparably fast. For said reason, maps are known where the paper/card sheet is finished by coating or lining/lamination on one or both sides with an applied transparent plastic film. Said map sheet is folded machine-made or by hand to a smaller and easier manageable format. It's considered standard of technology that printed map sheets made of paper, card, sythetic paper or synthetics are embossed with grooves to predefine the folds and afterwards are completely or partly folded machine-made. Said embossing can preferably take place for a map sheet with a paper weight of more than 80 g/m² is made before or after coating or lining/lamination with an applied transparent plastic film and can show numerous parallel or perpendicular grooves. The cover is printed either on the outer map surfaces of the finally folded map sheet or a separate cover made of printed paper/card sythetic paper or synthetics, which is if applicable finished by coating or lining/lamination with an applied transparent plastic film on one or both sides and is glued permanently or temporarily, laminar, spot bond or with a flap and with an appropriate glue to the finally folded map sheet. Said cover has printed an information about the contents of the map. If applicable there can be a map spine between both cover pages, a narrow, also bent surface, which connects the front and back page of the cover and is printed with a short information about the contents of the map. All said known maps have in the the finally folded format and manufactored condition a rectangular format in different physical sizes. If applicable the known map has an outer package, which is made from a transparent film or made of printed paper, card, sythetic paper or synthetics, which is if applicable finished by coating or lining/lamination with an applied transparent plastic film on one or both sides. Said outer package is produced out of transparent plastic film by shrink wrapping or covers and/or encircles said map like a banderole in vertical or horizontal direction and which has preferably the length of a respective map edge. The drawback of the said known maps is, that when darkness is arround they are very difficult to find. A great drawback of the laminate and longish map spine of known maps in the finally folded format is, that such map through the fixed width of the map spine either fans out at the lower edge of the map or the laminate map spine inclines in front or to the back and that the information printed on the map spine is not or very poorly readable. A further great drawback of known maps is that they can't be sold in the sales system peg-boards with s-hook, a world wide spread sales system for sales racks in cosumer markets, because the flap with the standard punched hole or standard punched hook is missing, which enables placement at such a hook.

It is an object of this present invention to provide an embodiment of map, which doesn't the mentioned drawbacks and has further advantages.

To achieve these objects the present invention provides two embodiments of a map, particularly for a country map, a road map, a street map, a city map, a hiking map, a bike map, a mountain bike map, motor cycle map, a public transport map, a nautical chart, a aviation chart, a pilotage chart, a geological chart, a achitectural plan, but also an infomation sheet, which is printed on a large sheet and is folded like map to a small and easy manageable format and an otherwise printed map sheet.

The map consists of:

a printed and folded paper, card, synthetic paper or sythetics, which has preferably a paper weight of more than 80 g/m²,
a seperate cover made of printed and folded paper, card, synthetic paper or sythetics, which is connected to the finally folded map sheet,
a firm connected or detachable flap with Integrated Standard Punched Hole or Integrated Standard Punched Hook, made of paper, card, synthetic paper or sythetics and printable or a separate Inventive Map Spine Part if applicable with a firm connected or detachable flap with Integrated Standard Punched Hole or Integrated Standard Punched Hook, made by plastic casting, or of paper, card, synthetic paper or sythetics and is printable,
an appropriate glue
an outer package made from a transperant plastic film or from paper, card, synthetic paper or sythetics and printable,
a coating or a lining/lamination with with an applied transparent plastic film on the map sheet and/or the cover and/or outer package and/or the flap and/or the Inventive Map Spine Part on one or both sides.

In the first embodiment of the map it's provided according the invention, that a known or Inventive Map has attached a firm connected or detachable flap with Integrated Standard Punched Hole or Integrated Standard Punched Hook in an Inventive Connection. Such a map is preferably made for retail sales. The “known map” is a continuous printed map sheet made of paper, card, synthetic paper or sythetics, which has preferably a paper weight of more than 80 g/m², which is if applicable finished by coating or lining/lamination with an applied transparent plastic film on one or both sides, has one or multiple fanfolds and is folded with one or multiple cross folds to finally folded format and has if applicable a “cover” printed on one or both sides of the outer map surfaces containing an information about the map. The separate cover is made of printed paper, card, sythetic paper or synthetics, which is if applicable finished by coating or lining/lamination with an applied transparent plastic film on one or both sides and is glued permanently or temporarily, laminar, spot bond, or with a flap and an appropriate glue to the finally folded map sheet. Between both cover pages of the map a map spine is formed, a narrow, also bent surface, which connects the front and back page of the cover and is printed with a short information about the contents of the map. All maps have in the the finally folded format and manufactored condition a rectangular format in different physical sizes. In alteration to the known maps the “Inventive Map” has an “Inventive Map Spine”, a round map spine, which is formed by a round cross fold at the upper edge of the map. This Inventive Map Spine is formed by an Inventive Grooving and followed by a round cross fold and/or is formed to a round Inventive Map Spine by a Inventive Thermal Deformation. For the “Inventive Grooving” at first the map sheet and/or cover are embossed with at least 3 and maximum with 15 parallel grooves, which are perpendicular to the fanfolds and are centered at the upper edge of the map, are parallel to it and have a equal interval of maximum 1,5 mm from eachother and afterwards are formed to a round cross fold and/or for the “Inventive Thermal Deformation” the map sheet and/or the cover is formed with a round component and simultanious heating to a round cross fold, a round Inventive Map Spine. Thereby at first a round cross fold is formed and then heated to a temperature of 40° C. to 200° C. and afterwards cooled down. The Inventive Thermal Deformation of the round Inventive Map Spine and/or of the other folds, the pointed fanfolds and of the other cross folds of the ready folded map are formed through the provided thermal heating and remain permanently after cooling down. If applicable such a map has an outer package, which is made from a transparent film or made of printed paper, card, sythetic paper or synthetics, which is if applicable finished by coating or lining/lamination with an applied transparent plastic film on one or both sides. Said outer package is produced of transparent plastic film by shrink wrapping or covers and/or encircles said map like a banderole in vertical or horizontal direction and has preferably the width of a respective map edge. Furtheron a map produced in such a way is in an Inventive Connection with an “Inventive Flap”, a firm connected or detachable flap with Integrated Standard Punched Hole or Integrated Standard Punched Hook in an inventive alignment. This Inventive Flap is made of printed paper, card, sythetic paper or synthetics, which is imprntable and if applicable finished by coating or lining/lamination with an applied transparent plastic film on one or both sides. This “Inventive Connection” is a permanent or temporary connection with an appropriate glue, which can be laminar, spot bond, or a connection with a flap. This Inventive Connection also accrues thereby, that this Inventive Flap is a part of the outer package or the cover or through the tention of a outer package which is shaped like a banderole and that this Inventive Flap can be separated from the map at a predefinded weak spot e.g. a perforation. In terms of the invention partable means that the Inventive Flap can be separated by hand without a further aid. The outer dimentions of the flap are measured in a way that the Integrated Standard Punched Hole or the Integrated Standard Punched Hook hava a surrounding border of minimum of 1 mm around the punching, and that this flap has preferably in a rectangular shape. associated with, that the “inventive alignment” of the map and the Inventive Flap is made in a way, that a placement in the sales racks of the system peg-boards with s-hook is enabled and that the Inventive Flap is aligned with the map spine such that the print on the map spine is easy readable. There are different suppliers of the sales system peg-boards with s-hooks on the world markets, nevertheless it's common to all systems, that the “hooks” consist of a longish, in front round holder made of wire or a arbor made of wire. Such holders made of wire have two long parallel sides in a same distance to eachother. The width of the holders made of wire, of the different systems offered in the market have only a little tolerance and the arbor has a fixed diameter and because of that a standard punched hole or standard punched hook is possible which is applicable for nearly all systems. The “standard punched hole” has a longish horizontal form, showing curves at both ends and has centered one or two salients, which form upwards or upwards and downwards a semicirle. Preferably the opening of this standard punched hole in horizontal direction a length of 35 mm, in vertical direction a length of 16 mm, the opening has a width of 8 mm and the curves at the ends a radius of 4 mm, and the salients a length and radius of 4 mm. The “standard punched hook” has a longish horizontal form, which has to one side an opening and inwards an upwards pointing round and a salient mounted centered on the flap, which forms a semicirle. Preferably the opening of the standard punched hook in horizontal direction a length of 25 mm, in vertical direction 12 mm, a width of 8 mm, and the salient a length and radius of 4 mm. Furtheron if applicable such an Inventive Flap is produced in different colours and/or with graphic attributes and/or printed with short informations, which enable a clear identification a certain map title when displayed consecutively on a hook of the system peg-boards with s-hook.

In the second embodiment of the map it's provided, that a known or Inventive Map has a separate Inventive Map Spine Part attached, and if applicable with a firm connected or detachable flap with Integrated Standard Punched Hole or Integrated Standard Punched Hook in an Inventive Arrangement, connected by a permanent or temporary bonding, which is laminar or a spot bond, with an appropriate glue. Such a map is preferably made for retail sales. For the second embodiment of the map the provisions and inventions of the first embodiment of map for the known map, the cover, the Inventive Map, the Inventive Map Spine, the Inventive Flap, to the Inventive Arrangement, the hook, the standard punched hole and the standard punched hook are valid. The separate “Inventive Map Spine Part” is shaped like a u-profile or like a longish flat body, which has a maximal length of the map spine of a map, is yet preferably 10 mm shorter on both sides. The round Inventive Map Spine Part is shaped like the profile of a segment of a bow of a longish cylindric round body. The angularly Inventive Map Spine Part is shaped like three blades of the profile of a longish cuboid. Both such Inventive Map Spine Part s have inside a longish opening in which the the map spine of a known or Inventive Map in the finally folded format fits. The Inventive Map has preferably attached to a round Inventive Map Spine Part, which spans the round Inventive Map Spine. The known map is preferably joind with an angularly Inventive Map Spine Part. The flat Inventive Map Spine Part is shaped like a flat body, which is attached to top of the the map spine of a known or Inventive Map. Furtheron the Inventive Map Spine Part if applicable has attached an Inventive Flap, an attachable or permantent flap with an Integrated Standard Punched Hole or Integrated Standard Punched Hook, in an Inventive Arrangement. Such an Inventive Flap is attached firmly to the Inventive Map Spine Part or is removable through weak spot as e.g. a thin film or a perforation. Thereby the removable flap can easy be separated at a given spot. Furtheron the Inventive Flap is attached to the Inventive Map Spine Part in a way that the printed short information is easy readable. Furtheron it's provided that the Inventive Map Spine Part is made by plastic casting, or of paper, card, synthetic paper or sythetics and preferably has a paper weight of minimum 80 g/m², is printable and if applicable finished by coating or lining/lamination with an applied transparent plastic film on one or both sides. The plasic casting is inventively made of plastics, which has a very soft consistance. Such are silicone plastics, but all other appropriate plastics can be utilized. Furtheron if applicable a plastic casting can be made from hard plastics or a Inventive Map Spine Part made out of paper, card, synthetic paper or synthetics can find utilization. Furtheron it's provided, that the Inventive Map Spine Part is produced with also transparent plastics and thereby the short information printed on the map spine is visable and/or that the Inventive Map Spine Part is produced with pastics, which also shines at night, thereto the utilized plastics contains a flourescent or otherwise at night shining or glowing colouring and is good visable at darkness.

The coating of the map sheet, the seperate cover, the outer package, the flap and of the Inventive Map Spine Part is produced by print varnish (varnishing while printing) or by UV-varnish (hereby the varnish is applied by a calender cylinder and hardened by a UV-lamp). Also other know coatings are considered.

The lined/laminated plastic films applied on the map sheet, the seperate cover, the outer package, the flap and of the Inventive Map Spine Part of are avantageously PET films (polyethylene terephthalate film) suitable for hot lamination but may alternatively be OPP films (oriented polypropylene film) for cold lamination. Other known laminating films may be considered.

The invention therefore provides means to produce a map which has a significant distinction from all other maps in the finally folded format and has further advantages. The Inventive Map with a round Inventive Map Spine has the advantage, that such a formed Inventive Map Spine adjusts itself to the thickness of the map in the finally folded format and that thereby the on the map spine printed short information about the map is good readable from the top, which has a great importance when archiving, at selling in shelves, in drawers and sales stands, as thereby only the map spine is visable from the top and for first checking of the contets there is now need to open the map. In the first embodiment of the map it's provided, that a known or Inventive Map has attached an Inventive Flap, a firm connected or detachable flap with Integrated Standard Punched Hole or Integrated Standard Punched Hook, in a Inventive Arrangement. In the second embodiment of the map it's provided, that a known or Inventive Map has attached a separate Inventive Map Spine Part, and if applicable with a firm connected or detachable flap with Integrated Standard Punched Hole or Integrated Standard Punched Hook in an Inventive Arrangement. Hereby the advantage accures, that a Inventive Map Spine Part which is produced with a soft plastics and attached to a map enables a easy opening, as it deforms and doesn't block opening, whereas the closing of the mapis benefited through the in the opened condition existing tention, which forces the Inventive Map Spine Part back to the form of origin. Also a invnetive Inventive Map Spine Part made by plastic casting with hard plastics or made of paper, card, synthetic paper or plastics allows to open the map, without having the advatages of a bendable Inventive Map Spine Part. Furtheron a also transparent Inventive Map Spine Part, that the short information printed on the map spine is good readable and plastics also shining at night permits a easy retrieving of the map at darkness. The great advantage of both embodiments of the map is, that a known or Inventive Map with an attached Inventive Flap in an Inventive Arrangement is suitable for the sales system peg-boards with s-hook, a world wide spread sales system for sales racks in cosumer markets. A further great advantage of both embodiments of the map is, that such maps, which have an Inventive Flap with standard punched hook attached, and when several such maps are placed consecutivly on a s-hook of the peg-boards, during sales not only the first map on the s-hook can be gathered, but also every single other map behind. A further advantage is that a map with an attached Inventive Flap, which is produced in different colours and/or with graphic attributes and/or printed with short informations a clear identification a certain map title is enabled, when displayed consecutivly on a hook. Thereby different maps, vis differing titles, can be displayed on one hook and later specific single ones can be gathered, without that the end-user is forced to remove all maps which are in front of it on the hook, to attain the chosen map. A further advantage is, that after purchasing the customer can remove the attached Inventive Flap easily.

It's therefore provided, that the map has several partculars of the invention.
a) Embodiment of the map, of a known or Inventive Map has attached a firm connected or detachable flap with Integrated Standard Punched Hole or Integrated Standard Punched Hook.
In the first embodiment of the map it's provided according the invention, that a known or Inventive Map has attached a firm connected or detachable flap with Integrated Standard Punched Hole or Integrated Standard Punched Hook in an Inventive Connection. The “known map” is a continuous printed map sheet made of paper, card, synthetic paper or sythetics, which has preferably a paper weight of more than 80 g/m², which is if applicable finished by coating or lining/lamination with an applied transparent plastic film on one or both sides, has one or multiple fanfolds and is folded with one or multiple cross folds to finally folded format and has if applicable a “cover” printed on one or both sides of the outer map surfaces containing an information about the map. The cover if applicable consists of separate sheet made of printed paper, card, sythetic paper or synthetics, which is if applicable finished by coating or lining/lamination with an applied transparent plastic film on one or both sides and is glued permanently or temporarily, laminar, spot bond, or with a flap and an appropriate glue to the finally folded map sheet. Between both cover pages of the map a map spine is formed, a narrow, also bent surface, which connects the front and back page of the cover and is printed with a short information about the contents of the map. All maps have in the the finally folded format and manufactored condition a rectangular format in different physical sizes. In alteration to the known maps the “Inventive Map” has an “Inventive Map Spine”, a round map spine, which is formed by a round cross fold at the upper edge of the map. This Inventive Map Spine is formed by an inventive grooving and followed by a round cross fold and/or is formed to a round Inventive Map Spine by a Inventive Thermal Deformation. For the “Inventive Grooving” at first the map sheet and/or cover are embossed with at least 3 and maximum with 15 parallel grooves, which are perpendicular to the fanfolds and are centered at the upper edge of the map, are parallel to it and have a equal interval of maximum 1,5 mm from eachother and afterwards are formed to a round cross fold and/or for the “Inventive Thermal Deformation” the map sheet and/or the cover are formed with a round component and simultanious heating to a round cross fold, a round Inventive Map Spine. Thereby at first a round cross fold is formed and then heated to a temperature of 40° C. to 200° C. and afterwards cooled down. The Inventive Thermal Deformation of the round Inventive Map Spine and/or of other folds, pointed fanfolds and of other cross folds of the finally folded map are formed through the provided thermal heating and remain permanently after cooling down. Furtheron if applicable such a map is provided with an outer package, which is preferably made from a transparent film or also made of paper, card, sythetic paper or synthetics, which is if applicable printed and if applicable finished by coating or lining/lamination with an applied transparent plastic film on one or both sides. Said outer package is produced of transparent plastic film by shrink wrapping or covers and/or encircles said map like a banderole in vertical or horizontal direction and has preferably the width of a respective map edge. Furtheron a map produced in such a way is in an Inventive Connection to an “Inventive Flap”, a firm connected or detachable flap with Integrated Standard Punched Hole or Integrated Standard Punched Hook in an inventive alignment. This Inventive Flap is made of printed paper, card, sythetic paper or synthetics, which is if applicable printable and if applicable finished by coating or lining/lamination with an applied transparent plastic film on one or both sides. This “Inventive Connection” is a permanent or temporary connection with an appropriate glue, which can be laminar, spot bond, or a connection with a flap. This Inventive Connection also accrues thereby, that this Inventive Flap is a part of the outer package or the cover or through the tention of a outer package which is shaped like a banderole and that the Inventive Flap can be separated from the map at a predefinded weak spot e.g. a perforation. The outer dimentions of the flap are measured in a way that the Integrated Standard Punched Hole or the integrated standard punchedhook have a surrounding border of minimum of 1 mm around the punching, and that this flap has preferably in a rectangular shape. associated with, that the “inventive alignment” of the map and the Inventive Flap is made in a way, that a placement in the sales racks of the system peg-boards with s-hook is enabled and that the Inventive Flap is aligned with the map spine such that the print on the map spine is easy readable. The “standard punched hole” has a longish horizontal form, showing curves at both ends and has centered one or two salients, which form upwards or upwards and downwards a semicirle. Preferably the opening of this standard punched hole in horizontal direction a length of 35 mm, in vertical direction a length of 16 mm, the opening has a width of 8 mm and the curves at the ends a radius of 4 mm, and the salients a length and radius of 4 mm. The “standard punched hook” has a longish horizontal form, which has to one side an opening and inwards an upwards pointing round and a salient mounted centered on the flap, which forms a semicirle. Preferably the opening of the standard punched hook in horizontal direction a length of 25 mm, in vertical direction 12 mm, a width of 8 mm, and the salient a length and radius of 4 mm. Furtheron if applicable such an Inventive Flap is produced in different colours and/or with graphic attributes and/or printed with short informations, which enable a clear identification a certain map title when displayed consecutivly on a hook of the system peg-boards with s-hook.
b) Embodiment of a map, of a known or Inventive Map has a separate Inventive Map Spine Part attached, with a firm connected or detachable flap with Integrated Standard Punched Hole or Integrated Standard Punched Hook.
In the second embodiment of the map it's provided, that a known or Inventive Map has a separate Inventive Map Spine Part connected, and if applicable with a firm connected or detachable flap with Integrated Standard Punched Hole or Integrated Standard Punched Hook in an Inventive Arrangement. Such a connection is a permanent or temporary bonding, which is laminar or a spot bond, with an appropriate glue. For the second embodiment of the map the provisions and inventions of the first embodiment of map for the known map, the cover, the Inventive Map, the Inventive Map Spine, the Inventive Flap, to the Inventive Arrangement, the hook, the standard punched hole and the standard punched hook are valid. The separate “Inventive Map Spine Part” is shaped like a u-profile or like a longish flat body, which has a maximal length of the map spine of a map, is yet preferably 10 mm shorter on both sides. The round Inventive Map Spine Part is shaped like the profile of a segment of a bow of a longish cylindric round body. The angularly Inventive Map Spine Part is shaped like three blades of the profile of a longish cuboid. The flat Inventive Map Spine Part is shaped like a flat body, which is attached to top of the the map spine of a known or Inventive Map. Furtheron the Inventive Map Spine Part if applicable has attached an Inventive Flap, an attachable or permantent flap with an Integrated Standard Punched Hole or Integrated Standard Punched Hook, in an Inventive Arrangement. Such an Inventive Flap is attached firmly to the Inventive Map Spine Part or is removable through weak spot as e.g. a thin film or a perforation. Furtheron the Inventive Flap is attached to the Inventive Map Spine Part in a way that the printed short information is easy readable. Furtheron it's provided that the Inventive Map Spine Part is made by plastic casting, or of paper, card, synthetic paper or sythetics and preferably has a paper weight of minimum 80 g/m², is printable and if applicable finished by coating or lining/lamination with an applied transparent plastic film on one or both sides. The plasic casting is inventively made of plastics, which has a very soft consistance. Such are silicone plastics, but all other appropriate plastics can be utilized. Furtheron if applicable a plastic casting can be made from hard plastics or a Inventive Map Spine Part made out of paper, card, synthetic paper or synthetics can find utilization. Furtheron it's provided, that the Inventive Map Spine Part is produced with also transparent plastics and thereby the short information printed on the map spine is visable and/or that the Inventive Map Spine Part is produced with pastics, which also shines at night, thereto the utilized plastics contains a flourescent or otherwise at night shining or glowing colouring and is good visable at darkness.

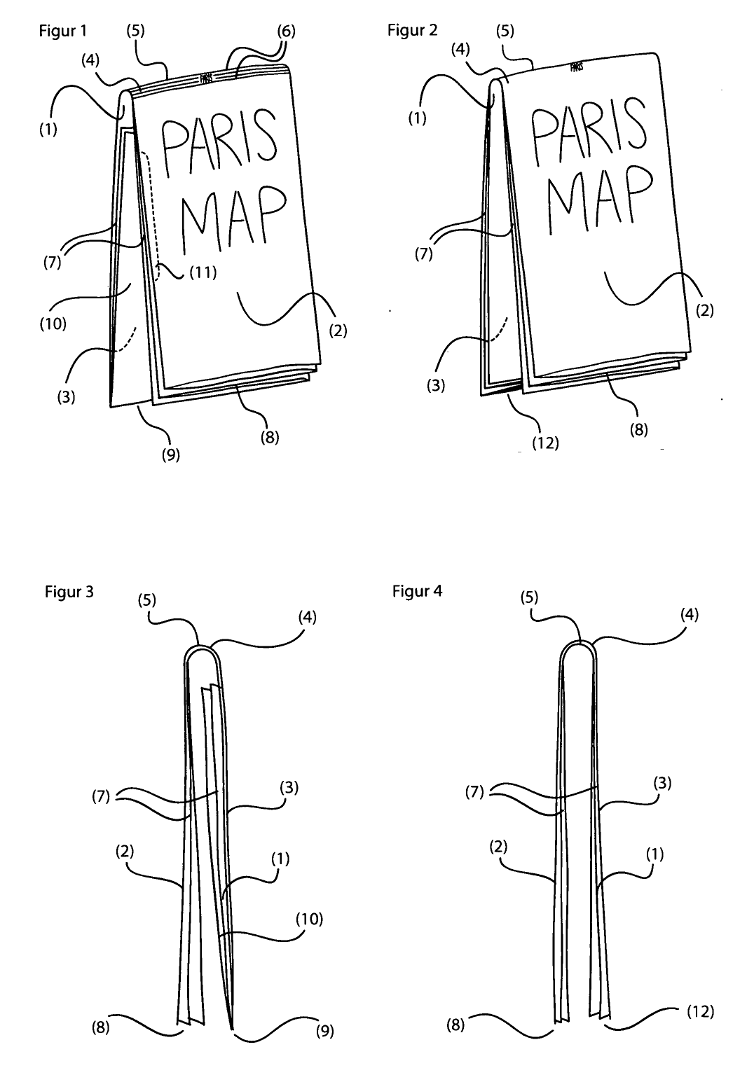

FIG. 1 shows in cavalier perspective an Inventive Map of Paris with an Inventive Map Spine formed by multiple parallel grooves and a further cross fold at a lower edge of the map

FIG. 2 shows in cavalier perspective an inventive Map of Paris a with an Inventive Map Spine formed by thermal deformation

FIG. 3 shows in side perspective an Inventive Map of Paris with an Inventive Map Spine formed with a further cross fold at a lower edge of the map

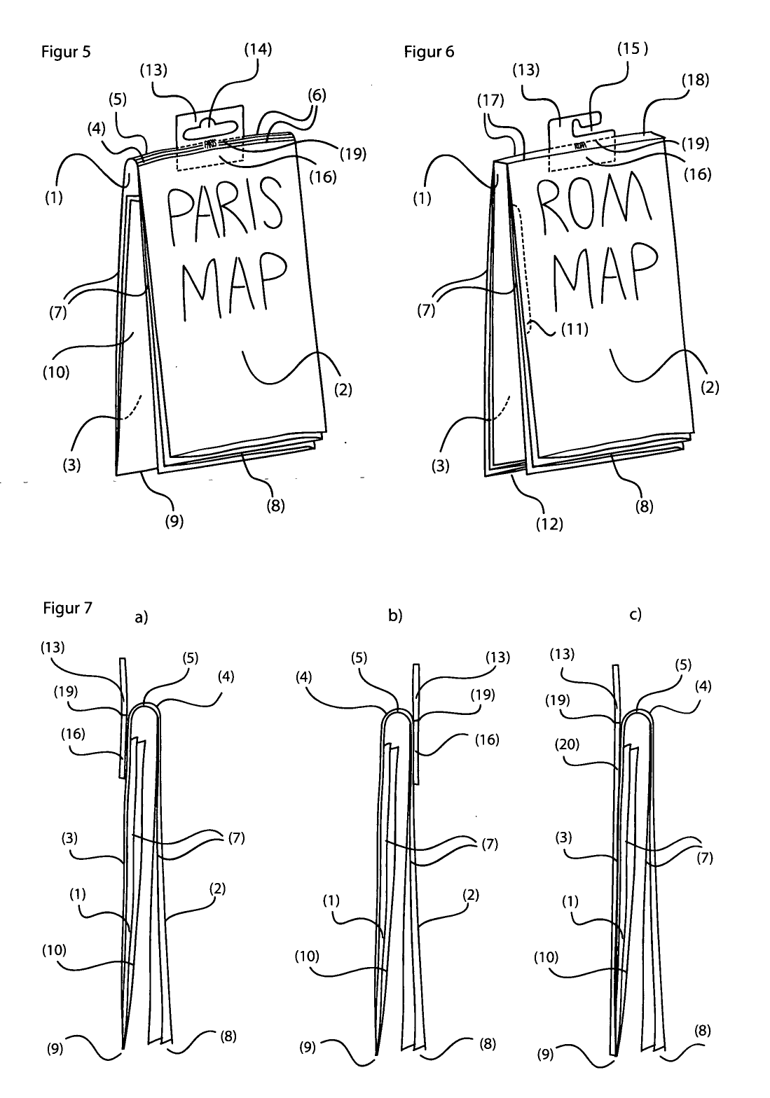

FIG. 4 shows in side perspective an inventive Map of Paris a with Inventive Map Spine

FIG. 5 shows in cavalier perspective an Inventive Map of Paris connected to an Inventive Flap with an Inventive Standard Punched Hole

FIG. 6 shows in cavalier perspective an known map of Rom connected to an Inventive Flap with an Inventive Standard Punched Hook

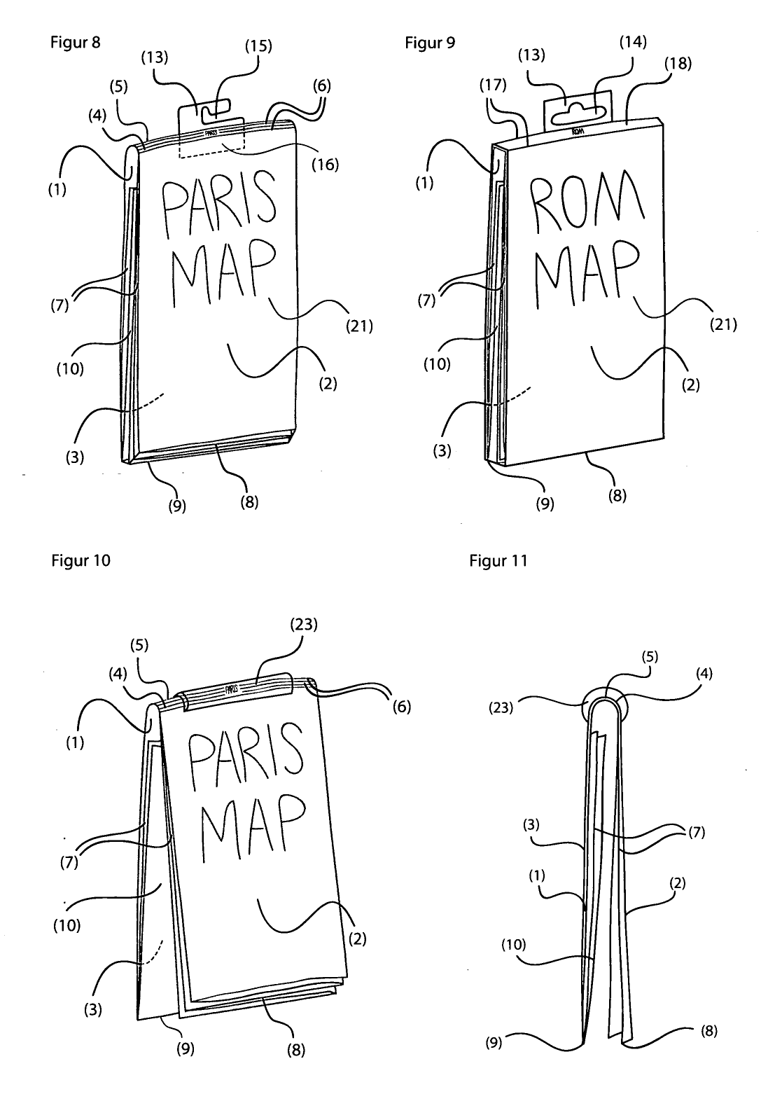

FIG. 7 shows in side perspective an Inventive Map connected to an Inventive Flat, in different examples

FIG. 8 shows in cavalier perspective an Inventive Map of Paris provided with a transparent outer package and connected to an Inventive Flap with an Integrated Standard Punched Hook

FIG. 9 shows in cavalier perspective an known map of Rom with a printed cover fromed like a banderole connected to an Inventive Flap with an Integrated Standard Punched Hole, which is apart of that cover

FIG. 10 shows in cavalier perspective an Inventive Map of Paris with an attached round Inventive Map Spine Part

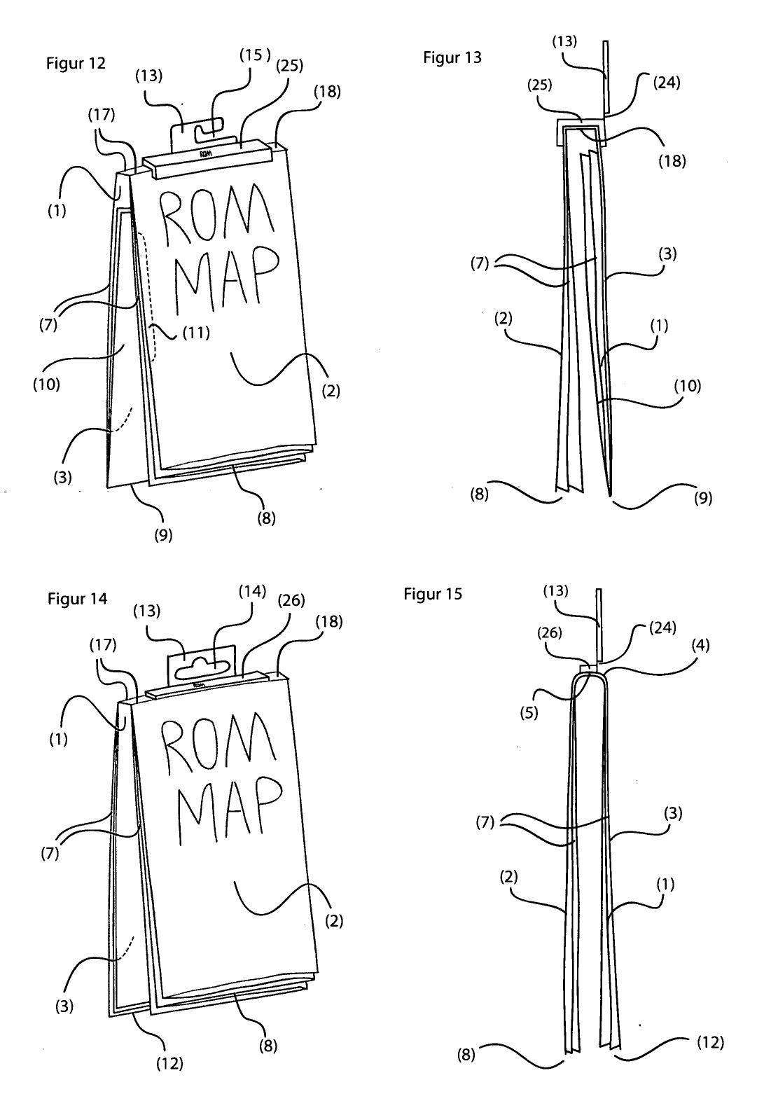

FIG. 11 shows in side perspective an Inventive Map of Paris with an attached round Inventive Map Spine Part

FIG. 12 shows in cavalier perspective an known map of Rom with a flat map spine with an attached angularly Inventive Map Spine Part and connected to an Inventive Flap with an Integrated Standard Punched Hook

FIG. 13 shows in side perspective an known map of Rom with a flat map spine with an attached angularly Inventive Map Spine Part and connected to an Inventive Flap

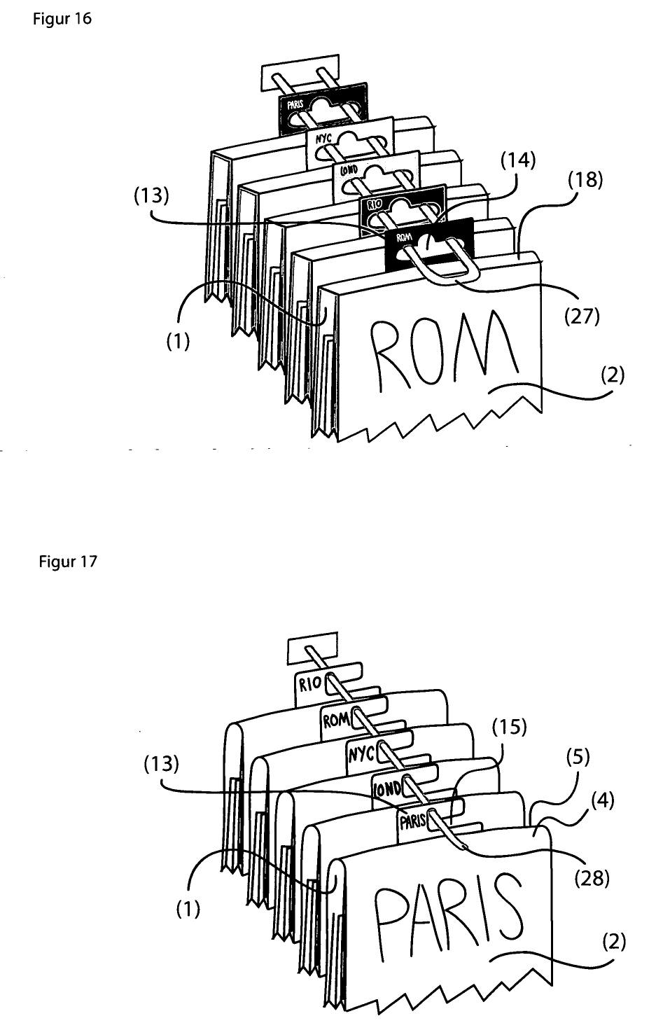

FIG. 14 shows in cavalier perspective an known map of Rom with a flat map spine with an attached flat Inventive Map Spine Part and connected to an Inventive Flap with an Integrated Standard Punched Hole

FIG. 15 shows in side perspective an Inventive Map of Paris with a round Inventive Map Spine and with an attached flat Inventive Map Spine Part and connected to an Inventive Flap

FIG. 16 shows in cavalier multiple different titles of known maps provided with an outer package in form of a banderole and with an attached Inventive Flap, which is a part of it, consecutively hang-up on a hook, a holder made of wire

FIG. 17 shows in cavalier multiple different titles of Inventive Maps provided with an outer package made from transpartent film by shrink wrapping and connected to an attached Inventive Flap, consecutively hang-up on a hook, a arbor made of wire

FIG. 1 shows in cavalier perspective an Inventive Map of Paris with an Inventive Map Spine formed by multiple parallel grooves and a further cross fold at a lower edge of the map

The map sheet (1) is in the finally folded format and has a front outer map surface and a back outer map surface. The folded Inventive Map has multiple vertical fanfolds (7). The fanfold at the lower, horizontal and front edge of the map (8) fans out and is stepped. Through a cross fold at the lower the lower, horizontal and back edge of the map (9) inwards the inner map surface (10) is formed. The separate sheet, on which the cover is printed on, has the front cover page (2), which is printed with the information “Paris Map” and the back cover page (3) and is attached to a flap (11) to the folded map sheet (1). Between these both cover pages at the upper edge of the map (5) a round Inventive Map Spine (4) is formed, which is made by multiple parallel grooves (6) and is printed with the short information “Paris” and which is visable from the top.

FIG. 2 shows in cavalier perspective an inventive Map of Paris a with an Inventive Map Spine formed by thermal deformation

The map sheet (1) is in the finally folded format and has a front outer map surface (2), the front cover page, which is printed with the information, “Paris Map” and a back outer map surface (3), the back cover page. Between these both cover pages at the upper edge of the map (5) a round Inventive Map Spine (4) is formed, which is formed round and is printed with the short information “Paris” and which is visable from the top. The folded Inventive Map has multiple vertical fanfolds (7). The fanfolds at the lower horizontal edges of the map (8) and (12) fan out and are stepped.

FIG. 3 shows in side perspective an Inventive Map of Paris with an Inventive Map Spine formed with a further cross fold at a lower edge of the map

The map sheet (1) is in the finally folded format and has a front outer map surface (2), the front cover page and a back outer map surface (3), the back cover page. Between these both cover pages at the upper edge of the map (5) a round Inventive Map Spine (4) is formed. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed.

FIG. 4 shows in side perspective an inventive Map of Paris a with Inventive Map Spine

The map sheet (1) is in the finally folded format and has a front outer map surface (2), the front cover page and a back outer map surface (3), the back cover page. Between these both cover pages at the upper edge of the map (5) a round Inventive Map Spine (4) is formed. The folded Inventive Map has multiple vertical fanfolds (7). The fanfolds at the lower horizontal edges of the map (8) and (12) fan out and are stepped.

FIG. 5 shows in cavalier perspective an Inventive Map of Paris connected to an Inventive Flap with an Inventive Standard Punched Hole

The map sheet (1) is in the finally folded format and has a front outer map surface (2), the front cover page, which is printed with the information, “Paris Map” and a back outer map surface (3), the back cover page. Between these both cover pages at the upper edge of the map (5) a round Inventive Map Spine (4) is formed, which is made by multiple parallel grooves (6) and is printed with the short information “Paris” and which is visable from the top. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. The Inventive Flap (13) with Integrated Standard Hole (14) is attached to the upper area of the back cover page (3) with a flap (16) and detachable at the weak spot (19), through perforation.

FIG. 6 shows in cavalier perspective an known map of Rom connected to an Inventive Flap with an Inventive Standard Punched Hook

The map sheet (1) is in the finally folded format and has a front outer map surface (2) and a back outer map surface (3). The folded Inventive Map has multiple vertical fanfolds (7). The fanfolds at the lower horizontal edges of the map (8) and (12) fan out and are stepped. The separate sheet, on which the cover is printed on, has the front cover page (2), which is printed with the information “Rom Map” and the back cover page (3) and is attached to a flap (11) to the folded map sheet (1). Between these both cover pages at the upper edge of the map (17) a flat map spine (18) is formed, which is printed with the short information “Rom” and which is visable from the top. The Inventive Flap (13) with Integrated Standard Hook (15) is attached to the upper area of the back cover page (3) with a flap (16) and detachable at the weak spot (19), through perforation.

FIG. 7 shows in side perspective an Inventive Map connected to an Inventive Flat, in different examples

The map sheet (1) is in the finally folded format and has a front outer map surface (2) and a back outer map surface (3). Between these both cover pages at the upper edge of the map (5) a round Inventive Map Spine (4) is formed. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed.
a) The Inventive Flap (13) is attached to the area of the upper back map surface (3) with a flap (16) to the map and detachable at the weak spot (19), through perforation.
b) The Inventive Flap (13) is attached to the area of the upper front map surface (2) with a flap (16) to the map and detachable at the weak spot (19), through perforation.
c) The Inventive Flap (13) is attached laminar all over to back map surface (3) with a vertical flap (20) to the map and detachable at the weak spot (19), through perforation.

FIG. 8 shows in cavalier perspective an Inventive Map of Paris provided with a transparent outer package and connected to an Inventive Flap with an Integrated Standard Punched Hook

The map sheet (1) is in the finally folded format and has a front outer map surface (2), the front cover page, which is printed with the information, “Paris Map” and a back outer map surface (3), the back cover page. Between these both cover pages at the upper edge of the map (5) a round Inventive Map Spine (4) is formed, which is made by multiple parallel grooves (6) and is printed with the short information “Paris” and which is visable from the top. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. That map is provided with a transparent outerpackage (21). The Inventive Flap (13) with Integrated Standard Hook (15) is attached to the upper area of the back cover page (3) with a flap (16).

FIG. 9 shows in cavalier perspective an known map of Rom with a printed cover fromed like a banderole connected to an Inventive Flap with an Integrated Standard Punched Hole, which is apart of that cover

The map sheet (1) is in the finally folded format and has a front outer map surface and a back outer map surface. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. The separate sheet, on which the cover is printed on, is shaped like a vertical banderole, and has the front cover page (2), which is printed with the information “Rom Map” and the back cover page (3) and the Inventive Flap (13) with Integrated Standard Punched Hole (14) is a part of the such shaped cover. Between these both cover pages at the upper edge of the map (17) a flat map spine (18) is formed, which is printed with the short information “Rom” and which is visable from the top.

FIG. 10 shows in cavalier perspective an Inventive Map of Paris with an attached round Inventive Map Spine Part

The map sheet (1) is in the finally folded format and has a front outer map surface (2), the front cover page, which is printed with the information, “Paris Map” and a back outer map surface (3), the back cover page. Between these both cover pages at the upper edge of the map (5) a round Inventive Map Spine (4) is formed, which is made by multiple parallel grooves (6) and is printed with the short information “Paris”, which is visable from the top. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. At the round Inventive Map Spine (4) a round Inventive Map Spine Part (23) is attached to the map, a plastic casting made from transparent plastics, The short information printed on map spine is through the transparent plastics and this arrangement readalbe from the top.

FIG. 11 shows in side perspective an Inventive Map of Paris with an attached round Inventive Map Spine Part

The map sheet (1) is in the finally folded format and has a front outer map surface (2), the front cover page and a back outer map surface (3), the back cover page. Between these both cover pages at the upper edge of the map (5) a round Inventive Map Spine (4) is formed. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. At the round Inventive Map Spine (4) a round Inventive Map Spine Part (23) is attached to the map, made by plastic casting.

FIG. 12 shows in cavalier perspective an known map of Rom with a flat map spine with an attached angularly Inventive Map Spine Part and connected to an Inventive Flap with an Integrated Standard Punched Hook

The map sheet (1) is in the finally folded format and has a front outer map surface and a back outer map surface. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. The separate sheet, on which the cover is printed on, has the front cover page (2), which is printed with the information “Rom Map” and the back cover page (3) and is connected to a flap (11) with the folded map sheet (1). Between these both cover pages at the upper edge of the map (17) a flat map spine (18) is formed. At the map spine (18) an angularly Inventive Map Spine Part (25) is attached to the map, a plastic casting made from opaque plastics and that is printed with the short information “Rom” and visable from the top and the Inventive Flap (13) with Integrated Standard Punched Hook (15) is a part of this map spine part.

FIG. 13 shows in side perspective an known map of Rom with a flat map spine with an attached angularly Inventive Map Spine Part and connected to an Inventive Flap

The map sheet (1) is in the finally folded format and has a front outer map surface and a back outer map surface. Between these both cover pages at the upper edge of the map (17) a flat map spine (18) is formed. The folded Inventive Map has multiple vertical fanfolds (7). The fanfold at the lower, horizontal and front edge of the map (8) fans out and is stepped. Through a cross fold at the lower, horizontal and back edge of the map (9) inwards the inner map surface (10) is formed. At the map spine (18) an angularly Inventive Map Spine Part (25) is attached to the map and the Inventive Flap (13) is detachable at a weak spot, through a thin film.

FIG. 14 shows in cavalier perspective an known map of Rom with a flat map spine with an attached flat Inventive Map Spine Part and connected to an Inventive Flap with an Integrated Standard Punched Hole

The map sheet (1) is in the finally folded format and has a front outer map surface (2) has the front cover page, which is printed with the information “Rom Map” and a back outer map surface (3), the back cover page. nted on, and (3) and is connected to a flap (11) with the folded map sheet (1). Between these both cover pages at the upper edge of the map (17) a flat map spine (18) is formed. The folded Inventive Map has multiple vertical fanfolds (7). The fanfolds at the lower horizontal edges of the map (8) and (12) fan out and are stepped. Through a cross fold at the lower, horizontal and back edge of the map (9) inwards the inner map surface (10) is formed. At the map spine (18) a flat Inventive Map Spine Part (26) is attached to the map, which is printed with the short information “Rom” and visable from the top and the Inventive Flap (13) with Integrated Standard Punched Hole (13) is a part of this map spine part.

FIG. 15 shows in side perspective an Inventive Map of Paris with a round Inventive Map Spine and with an attached flat Inventive Map Spine Part and connected to an Inventive Flap

The map sheet (1) is in the finally folded format and has a front outer map surface (2) and a back outer map surface (3). Between these both cover pages at the upper edge of the map (5) a round Inventive Map Spine (4) is formed. The folded Inventive Map has multiple vertical fanfolds (7). The fanfolds at the lower horizontal edges of the map (8) and (12) fan out and are stepped. At the round Inventive Map Spine (4) a flat Inventive Map Spine Part (26) is attached to the map and the Inventive Flap (13), which is a part of this map spine part, is detachable at a weak spot, through a perforation.

FIG. 16 shows in cavalier multiple different titles of known maps provided with an outer package in form of a banderole and with an attached Inventive Flap, which is a part of it, consecutively hang-up on a hook, a holder made of wire

The separate sheet, on which the cover of a known map is printed on, has the front cover page (2), which is printed with the information “Rom” and is connected to the folded map sheet (1). Between these both upper edges of the map a flat map spine (18) is formed. The Inventive Flap (13) with Integrated Standard Punched Hole (14) is coloured differently and printed with the short information e.g. “Rom” and connected to the map. Such colouring and printed short information is related to the attached map title. Several such maps are hung-up consecutively on a hook, a holder of wire (27) and is through the such produced Inventive Flap identified each for itself definitly.

FIG. 17 shows in cavalier multiple different titles of Inventive Maps provided with an outer package made from transpartent film by shrink wrapping and connected to an attached Inventive Flap, consecutively hang-up on a hook, a arbor made of wire

The map sheet (1) is in the finally folded format and has the front cover page (2), which is printed with the information “Paris”. At the upper edge of the map (5) a round Inventive Map Spine (4) is formed. The Inventive Flap (13) with Integrated Standard Punched Hook (15) is printed with the short information e.g. “Paris” and connected to the map. Such printed short information is related to the attached map title. Several such maps are hung-up consecutively on a hook, a arbor of wire (28) and is through the such produced Inventive Flap identified each for itself definitly.

What is claimed:

1. A map, particularly for a country map, a road map, a street map, a city map, a hiking map, a bike map, a mountain bike map, motor cycle map, a public transport map, a nautical chart, a aviation chart, a pilotage chart, a geological chart, a achitectural plan, but also an infomation sheet, which is printed on a large sheet and is folded like map to a small and easy manageable format and an otherwise printed map sheet. comprising:
a printed and folded map sheet, made of paper, card, synthetic paper or synthetics, and
wherein this map has at the upper map edge (5) between both cover pages a round map sine (4), a round cross fold, formed by gooves and/or thermal deformation.

2. The map according to claim 1, and
Wherein, that cover is printed on the one or both outer map surfaces (2) and (3) of the folded map sheet.

3. The map according to claim 1. and a seperate cover and connection comprising:
a printed and folded sheet, made of paper, card, synthetic paper or synthetics, and
an appropriate glue, and
wherein that this seperate cover is glued permanently or temporarily, laminar, spot bond, or with a flap (11) and an appropriate glue to the finally folded map sheet (1). Such cover froms at the upper map edge (5) between both cover pages a round map spine (4), a round cross fold, which is formed by gooves and/or thermal deformation.

4. The map according to one of the claims 1 to 3. and an outer package comprising:
a folded and otherwise formed sheet, made of paper, card, synthetic paper or synthetics, and
wherein a map is provided with a outer package, which is printed or not. The outer package is either produced of transparent plastic film by shrink wrapping or covers and/or encircles such a map like a banderole in vertical or horizontal direction and has preferably the width of a respective map edge.

5. The map according to one of the claims 1. or 4. and a flap comprising:
a punched and/or folded sheet, made of paper, card, synthetic paper or synthetics, and
wherein such a map is connected to a firm connected or detachable flap (13) with integrated standard punched hole (14) or integrated standard punched hook (15), which is printed or not.

6. A known map and a flap comprising:
a punched and/or folded sheet, made of paper, card, synthetic paper or synthetics, and
wherein a konwn map is connected to a firm connected or detachable flap (13) with integrated standard punched hole (14) or integrated standard punched hook (15), which is printed or not.

7. The map according to claim 6. and an outer package comprising:
a folded or otherwise formed sheet, made of paper, card, synthetic paper or synthetics, and
wherein a known map is provided with a outer package, which is printed or not. The outer package is either produced of transparent plastic film by shrink wrapping or covers and/or encircles such a map like a banderole in vertical or horizontal direction and has preferably the width of a respective map edge and that such produced map is connected to a firm connected or detachable flap (13) with integrated standard punched hole (14) or integrated standard punched hook (15), which is attached to the outside of the outer package and is printed or not.

8. The map according to one of the claims from 1. to 3. or a known map, a map spine part and a connection comprising:
a formed component, made of paper, card, synthetic paper or synthetics or a plastic casting,
an appropriate glue, and
wherein such a map is attached to a separate map sine part in a permanent or temporar connection, laminar, spot bond, with an appropriate glue, which is printed or not. Such map spine part is shaped like a u-profile or like a longish flat body, which has a maximal length of the map spine of a map, is yet preferably 10 mm shorter on both sides. Thereby the round map spine part (21) is shaped like the profile of a segment of a bow of a longish cylindric round body or the angularly map spine part (23) is shaped like three blades of the profile of a longish cuboid or the flat map spine part (24) is shaped like a flat body, which is attached to round the map spine (4) or to the flat map spine (17).

9. The map according to claim 8. and a flap comprising:
a formed component, made of paper, card, synthetic paper or synthetics or a plastic casting,
wherein such a map spine part is connected to a firm connected or detachable flap (13) with an integrated standard punched hole (14) or an integrated standard punched hook (15), which a part of the map spine part and printed or not. Such a flap is detachable through a connection with a weak spot (22), as e.g. a thin film or perforation.

10. The map according to one of the claims from 1. to 9 and a finishing comprising:
a coating or a lining/lamination with with an applied transparent plastic film on the map sheet and/or the cover and/or outer package and/or the flap and/or the formed component on one or both sides, and
wherein the coating is a print-varnish or UV-varnish coating or the lined/laminated transparent plastic film applied is a PET-film (polyethylene terephthalate film), for hot lamination or a OPP-film (oriented polypropylene film), for cold lamination. Other known coatings and lining/lamination films are considered for use.

11. The map according to one of the claims from 8. to 10. and
wherein such map spine part or map spine part with a flap (13) is made of plastic casting and produced from a plastics which has a very soft consistance. Such are silicone plastics, but all other appropriate plastics can be utilized.

12. The map according to one of the claims from 8. to 10. and
wherein such map spine part or map spine part with a flap (13) is made of plastic casting and produced from a plastics which has a hard consistance.

13. The map according the claim 11. or 12. and
wherein such map spine part or map spine part with a flap (13) is made of plastic casting and produced from a plastics which is an also transparent plastics.

14. The map according one of the claims from 11. to 14. and
wherein such map spine part or map spine part with a flap (13) is made of plastic casting and produced from a plastics that also shines at night. Thereto the utilized plastics contains a flourescent or otherwise at night shining or glowing colouring.

15. The map according to one of the claims from 1. to 14. and
wherein its provided for the round map spine (4) that: For grooving the map sheet (1) and/or the separate cover is embossed with at least 3 and maximum with 15 parallel grooves, which are perpendicular to the fanfolds and are centered at the upper edge of the map, are parallel to it and have a equal interval of maximum 1,5 mm from each other and afterwards are formed to a round cross fold and/or for thermal deformation the map sheet (1) and/or the separate cover are at the upper map edge using a round component and simultanious heating to a round cross fold. Thereby the a round cross fold is formed and heated to a temperature of 40° C. to 200° C. and cooled down afterwards. The thermal deformation of the round map spine and/or of other folds, pointed fanfolds (7) and of other cross folds (9) of the finally folded map sheet are formed through the provided thermal heating and remain permanently after cooling down.

16. The map according to one of the claims from 5. to 7. comprising:
a appropriate glue and
wherein such a flap is connected to the map in a permanent or temporary connection, which can be laminar, spot bond, or a connection with a flap, with an appropriate glue. Such connection also accrues thereby, that this flap is a part of the outer package or the cover or through the tention of a outer package which is shaped like a banderole and that the flap can be separated from the map at a predefinded weak spot.

17. The map according to one of the claims 5. to 7. or 9. to 16. and
wherein for such a flap (13) with an intergrated standard punched hole (14) or an integrated standard punched (15) is provided: The standard punched hole (14) has a longish horizontal form, showing curves at both ends and has centered one or two salients, which form upwards or upwards and downwards a semicirle. Preferably the opening of this standard punched hole (14) in horizontal direction a length of 35 mm, in vertical direction a length of 16 mm, the opening has a width of 8 mm and the curves at the ends a radius of 4 mm, and the salients a length and radius of 4 mm. The standard punched hook (15) has a longish horizontal form, which has to one side an opening and inwards an upwards pointing round and a salient mounted centered on the flap, which forms a semicirle. Preferably the opening of the standard punched hook in horizontal direction a length of 25 mm, in vertical direction 12 mm, a width of 8 mm, and the salient a length and radius of 4 mm. The outer dimentions of the flap (13) are measured in a way that the integrated standard punched hole (14) or the integrated standard punched hook (15) have a surrounding border of minimum of 1 mm around the punching, and that this flap has preferably in a rectangular shape associated with, that the alignment of the map and the flap is made in a way, that a placement in the sales racks of the system peg-boards with s-hook is enabled and that the flap is aligned with the map spine such that the print on the map spine is easy readable.

18. The map according to one of the claims 5. to 17. and
Wherein such a flap (13) with an intergrated standard punched hole (14) or an integrated standard punched (15) is produced in different colours and/or with graphic attributes and/or printed with short informations, which enable a clear identification a certain map title when displayed consecutivly on a hook.

19. The map according to one of the claims 5. to 18. and
wherein such a map is made for retail sales.
